(19) United States
(12) Patent Application Publication
(10) Pub. No.: US 2024/0331184 A1
(43) Pub. Date: Oct. 3, 2024

(54) SYSTEMS AND METHODS FOR IDENTIFYING A SIZE OF A COOKWARE ITEM

(71) Applicant: Haier US Appliance Solutions, Inc., Wilmington, DE (US)

(72) Inventors: Omar Santana, Louisville, KY (US); Khalid Jamal Mashal, Louisville, KY (US)

(21) Appl. No.: 18/194,865

(22) Filed: Apr. 3, 2023

(51) Int. Cl. G06T 7/62; F24C 1/08; F24C 7/08; G06T 3/40; G06V 10/74

(52) U.S. Cl. CPC G06T 7/62; F24C 1/08; F24C 7/083; G06T 3/40; G06V 10/761

(57) ABSTRACT

A cooking appliance including a cooktop including a plurality of heating zones, each heating zone heated by at least one heating element; an image capture device directed toward the cooktop; and a controller operably connected to the image capture device and the at least one heating element, wherein the controller is configured to perform an operation. The operation includes receiving one or more inputs relating to a cooking operation; receiving an image signal of the cooktop via the image capture device after receiving the one or more inputs, the image signal including a cookware item; identifying a size of the cookware item in the received image signal; adjusting one or more parameters of the cooking operation based on the identified size of the cookware item; and initiating the cooking operation based on the one or more adjusted parameters.

### FIELD OF THE INVENTION

The present subject matter relates generally to systems for aiding cooking operations, and more particularly to methods for monitoring and managing cooktop cookware items.

### BACKGROUND OF THE INVENTION

Cooktop or range appliances generally include heating elements for heating cooking utensils, such as pots, pans, and griddles. A variety of configurations can be used for the heating elements located on the cooking surface of the cooktop. The number of heating elements or positions available for heating on the range appliance can include, for example, four, six, or more depending upon the intended application and preferences of the buyer. These heating elements can vary in size, location, and capability across the appliance.

Moreover, multiple different types of cookware items may be used on cooktop appliances. For instance, small, medium, or large saucepans may be used, small, medium, or large frying pans may be used, or the like. Each of the different cookware items may exhibit differing heating properties according to their size, in addition to other factors such as material, coating, etc. Therefore, using universal operational parameters for the heating elements providing heat to the cookware items may result in decreased performance, under-cooking, over-cooking, or the like.

Accordingly, a cooking appliance that obviates one or more of the above-mentioned drawbacks would be beneficial. In particular, a cooking appliance that determines a cookware item size and adjusts parameters accordingly would be useful.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a cooking appliance is provided. The cooking appliance may include a cooktop including a plurality of heating zones, each heating zone heated by at least one heating element; an image capture device directed toward the cooktop; and a controller operably connected to the image capture device and the at least one heating element, wherein the controller is configured to perform an operation. The operation may include receiving one or more inputs relating to a cooking operation; receiving an image signal of the cooktop via the image capture device after receiving the one or more inputs, the image signal including a cookware item; identifying a size of the cookware item in the received image signal; adjusting one or more parameters of the cooking operation based on the identified size of the cookware item; and initiating the cooking operation based on the one or more adjusted parameters.

In another exemplary aspect of the present disclosure, a method of operating a cooking appliance is provided. The cooking appliance may include a plurality of heating zones, each heating zone selectively heated by at least one heating element, and an image capture device directed toward the plurality of heating zones. The method may include receiving one or more inputs relating to a cooking operation; receiving an image signal of the plurality of heating zones via the image capture device after receiving the one or more inputs, the image signal including a cookware item; identifying a size of the cookware item in the received image signal; adjusting one or more parameters of the cooking operation based on the identified size of the cookware item; and initiating the cooking operation based on the one or more adjusted parameters.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front perspective view of a system according to exemplary embodiments of the present disclosure.

FIG. 2 provides a side schematic view of the exemplary system of FIG. 1.

FIG. 3 provides a top view of a cooktop appliance of the exemplary system of FIG. 1 defining a plurality of zones.

FIG. 4 provides a table of exemplary cookware size adjustment methods according to exemplary embodiments.

FIG. 5 provides a schematic view of a display panel of the exemplary cooktop appliance of FIG. 3 showing menu selections.

FIG. 6 provides a flow chart illustrating a method of operating a system according to exemplary embodiments of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As shown, cooking appliance 300 defines a vertical direction V, a lateral direction L, and a transverse direction T, for example, at a cabinet 310. The vertical, lateral, and transverse directions are mutually perpendicular and form an orthogonal direction system. As shown, cooking appliance 300 extends along the vertical direction V between a top portion 312 and a bottom portion 314; along the lateral direction L between a left side portion and a right side portion; and along the traverse direction T between a front portion and a rear portion. The orthogonal direction system described herein may apply to each of cooking appliance 300, interactive assembly 110, or system 100 as a whole.

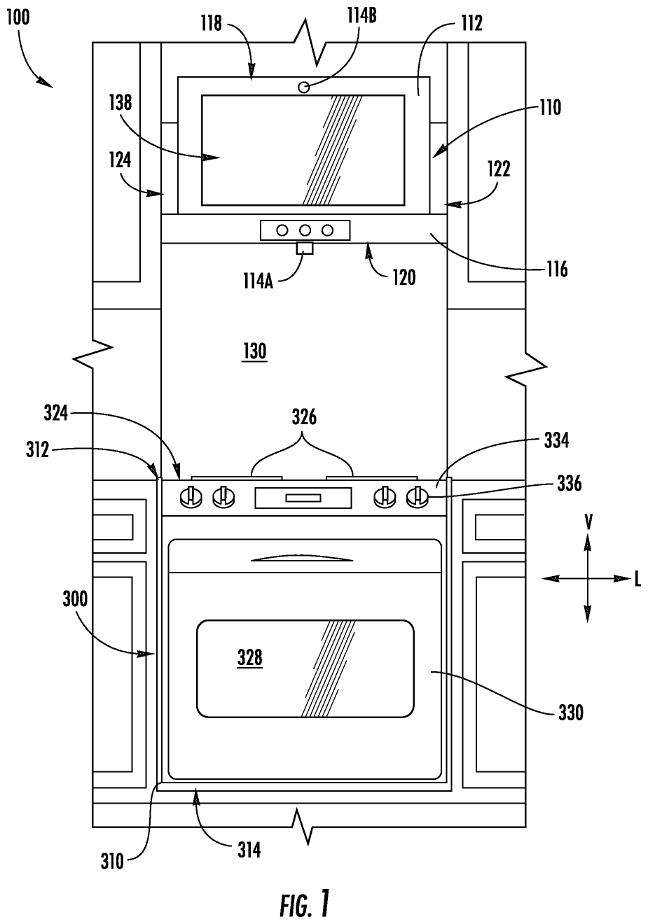

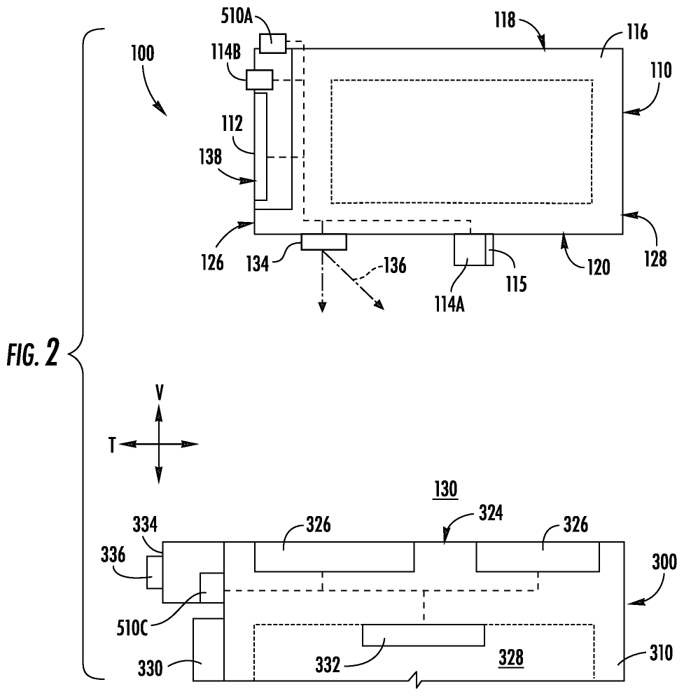

Turning to the figures, FIGS. 1 and 2 provide various views of a system 100 according to exemplary embodiments of the present disclosure. System 100 generally includes a stationary interactive assembly 110 with which a user may interact or engage. Interactive assembly 110 may have a controller 510A in operable communication with an image monitor 112 and one or more camera assemblies (e.g., camera assembly 114A and camera assembly 114B) that are generally positioned above a cooking appliance 300. However, it should be understood that the disclosure may be applicable to cooking appliances without image monitor 112 or camera assembly 114B. Accordingly, hereinafter, references made to a camera assembly will refer to camera assembly 114A. Additionally or alternatively, multiple individual cameras or image capture devices may be included within camera assembly 114A.

Cooking appliance 300 can include a chassis or cabinet 310 and a cooktop surface 324 having one or more heating elements 326 for use in, for example, heating or cooking operations. In exemplary embodiments, cooktop surface 324 is constructed with ceramic glass. In other embodiments, however, cooktop surface 324 may include another suitable material, such as a metallic material (e.g., steel) or another suitable non-metallic material. Heating elements 326 may be various sizes and may employ any suitable method for heating or cooking an object, such as a cooking utensil (not shown), and its contents. In one embodiment, for example, heating element 326 uses a heat transfer method, such as electric coils or gas burners, to heat the cooking utensil. In another embodiment, however, heating element 326 uses an induction heating method to heat the cooking utensil directly. In turn, heating element 326 may include a gas burner element, resistive heat element, radiant heat element, induction element, or another suitable heating element. It should be noted that one or more additional sensors may be included within cooktop surface 324 (e.g., at or adjacent to heating elements 326), such as weight sensors, contact sensors, proximity sensors, or the like for determining a positioning of cookware items or utensils thereon.

In some embodiments, cooking appliance 300 includes an insulated cabinet 310 that defines a cooking chamber 328 selectively covered by a door 330. One or more heating elements 332 (e.g., top broiling elements or bottom baking elements) may be enclosed within cabinet 310 to heat cooking chamber 328. Heating elements 332 within cooking chamber 328 may be provided as any suitable element for cooking the contents of cooking chamber 328, such as an electric resistive heating element, a gas burner, microwave element, halogen element, etc. Thus, cooking appliance 300 may be referred to as an oven range appliance. As will be understood by those skilled in the art, cooking appliance 300 is provided by way of example only, and the present subject matter may be used in any suitable cooking appliance, such as a standalone cooktop (e.g., fitted integrally with a surface of a kitchen counter). Thus, the example embodiments illustrated in figures are not intended to limit the present subject matter to any particular cooking chamber or heating element configuration, except as otherwise indicated.

As illustrated, a user interface or user interface panel 334 may be provided on cooking appliance 300. Although shown at the front portion of cooking appliance 300, another suitable location or structure (e.g., a backsplash) for supporting user interface panel 334 may be provided in alternative embodiments. In some embodiments, user interface panel 334 includes input components or controls 336, such as one or more of a variety of electrical, mechanical, or electro-mechanical input devices. Controls 336 may include, for example, rotary dials, knobs, push buttons, and touch pads. A controller 510C is in communication with user interface panel 334 and controls 336 through which a user may select various operational features and modes and monitor progress of cooking appliance 300. In additional or alternative embodiments, user interface panel 334 includes a display component, such as a digital or analog display in communication with a controller 510C and configured to provide operational feedback to a user. In certain embodiments, user interface panel 334 represents a general purpose I/O (“GPIO”) device or functional block.

As shown, controller 510C is communicatively coupled (i.e., in operative communication) with user interface panel 334 and its controls 336. Controller 510C may also be communicatively coupled with various operational components of cooking appliance 300 as well, such as heating elements (e.g., 326, 332), sensors, etc. Input/output (“I/O”) signals may be routed between controller 510C and the various operational components of cooking appliance 300. Thus, controller 510C can selectively activate and operate these various components. Various components of cooking appliance 300 are communicatively coupled with controller 510C via one or more communication lines such as, for example, conductive signal lines, shared communication busses, or wireless communications bands.

In some embodiments, controller 510C includes one or more memory devices and one or more processors. The processors may be any combination of general or special purpose processors, CPUs, or the like that can execute programming instructions or control code associated with operation of cooking appliance 300. The memory devices (i.e., memory) may represent random access memory such as DRAM or read only memory such as ROM or FLASH. In one embodiment, the processor executes programming instructions stored in the memory. The memory may be a separate component from the processor or may be included onboard within the processor. Alternatively, controller 510C may be constructed without using a processor, for example, using a combination of discrete analog or digital logic circuitry (such as switches, amplifiers, integrators, comparators, flip-flops, AND gates, and the like) to perform control functionality instead of relying upon software.

In certain embodiments, controller 510C includes a network interface such that controller 510C can connect to and communicate over one or more networks (e.g., wireless networks) with one or more network nodes. Controller 510C can also include one or more transmitting, receiving, or transceiving components for transmitting/receiving communications with other devices communicatively coupled with cooking appliance 300. Additionally or alternatively, one or more transmitting, receiving, or transceiving components can be located off board controller 510C. Generally, controller 510C can be positioned in any suitable location throughout cooking appliance 300. For example, controller 510C may be located proximate user interface panel 334 toward the front portion of cooking appliance 300.

As shown, one or more casings (e.g., hood casing 116) may be provided above cooking appliance 300 along the vertical direction V. For example, a hood casing 116 may be positioned above cooking appliance 300 in a stationary mounting (e.g., such that operation of interactive assembly 110 is not permitted unless casing 116 is mounted at a generally fixed or non-moving location). Hood casing 116 may include a plurality of outer walls and may generally extend along the vertical direction V between a top end 118 and a bottom end 120; along the lateral direction L between a first side end 122 and a second side end 124; and along the transverse direction T between a front end 126 and a rear end 128. In some embodiments, hood casing 116 is spaced apart from cooktop surface 324 along the vertical direction V. An open region 130 may thus be defined along the vertical direction V between cooktop surface 324 and bottom end 120.

In optional embodiments, hood casing 116 is formed as a range hood. A ventilation assembly within hood casing 116 may thus direct an airflow from the open region 130 and through hood casing 116. However, a range hood is provided by way of example only. Other configurations may be used within the spirit and scope of the present disclosure. For example, hood casing 116 could be part of a microwave or other appliance designed to be located above cooking appliance 300 (e.g., directly above cooktop surface 324). Moreover, although a generally rectangular shape is illustrated, any suitable shape or style may be adapted to form the structure of hood casing 116.

In certain embodiments, one or more camera assemblies (e.g., camera assembly 114A) are provided to capture images (e.g., static images or dynamic video) of a portion of cooking appliance 300 or an area adjacent to cooking appliance 300. Generally, camera assembly 114A may be any type of device suitable for capturing a picture or video. As an example, camera assembly 114A may be a video camera or a digital camera with an electronic image sensor [e.g., a charge coupled device (CCD) or a CMOS sensor]. Camera assembly 114A may be provided in operable communication with controller 510A and/or controller 510C such that controller 510A or 510C may receive an image signal from camera assembly 114A corresponding to the picture captured by camera assembly 114A. Once received by the controller, the image signal may be further processed (e.g., at controller 510A or 510C or transmitted to a separate device (such as a remote server) in live or real-time for remote viewing (e.g., via one or more social media platforms). Optionally, one or more microphones (not pictured) may be associated with one or more of the camera assemblies 114A, 114B to capture and transmit audio signal(s) coinciding (or otherwise corresponding) with the captured image signal(s).

In some embodiments, at least one camera assembly (e.g., camera assembly 114A) is directed at cooktop surface 324. In other words, camera assembly 114A is oriented to capture light emitted or reflected from cooktop surface 324 through the open region 130. Thus, camera assembly 114A may selectively capture an image covering all or some of cooktop surface 324. For instance, camera assembly 114A may capture an image covering one or more heating elements 326 of cooking appliance 300. Optionally, camera assembly 114A may be directed such that a line of sight is defined from camera assembly 114A that is perpendicular to cooktop surface 324. Additionally or alternatively, camera assembly 114A may provide a live feed (e.g., continuous capture image signals) to the controller (e.g., controller 510A) which may then be analyzed in real time.

As shown, camera assembly 114A is positioned above cooktop surface 324 (e.g., along the vertical direction V). In some such embodiments, camera assembly 114A is mounted (e.g., fixedly or removably) to hood casing 116. A cross-brace extending across hood casing 116 (e.g., along the transverse direction T) may support camera assembly 114A. When assembled, camera assembly 114A may be positioned directly above cooktop surface 324.

In optional embodiments, a lighting assembly 134 is provided above cooktop surface 324 (e.g., along the vertical direction V). For instance, lighting assembly 134 may be mounted to hood casing 116 (e.g., directly above cooktop surface 324). Generally, lighting assembly 134 includes one or more selectable light sources directed toward cooktop surface 324. In other words, lighting assembly 134 is oriented to project a light (as indicated at arrows 136) to cooking appliance 300 through open region 130 and illuminate at least a portion of cooktop surface 324. The light sources may include any suitable light-emitting elements, such as one or more light emitting diode (LED), incandescent bulb, fluorescent bulb, halogen bulb, etc.

Referring to FIG. 3, cooktop surface 324 may include a plurality of heating elements (or burners) 326. The heating elements 326 may be spaced apart from each other on cooktop surface 324. For instance, cooktop surface 324 may define a plurality of zones (e.g., cooking zones) 340. In the embodiment shown in FIG. 3, cooktop surface 324 includes 5 zones, 4 of which include a heating element 326. The zones may be arranged according to location on cooktop surface 324. Accordingly, cooktop surface 324 may include a right front (RF) zone, a right rear (RR) zone, a left front (LF) zone, and a left rear (LR) zone. The fifth zone may include a user interface (e.g., user interface panel 334). However, it should be noted that any suitable number of zones 340 may be formed including any suitable number of heating elements 326 or controls, and the disclosure is not limited to the examples shown and described herein.

The zones 340 may be defined and stored within controller 510C. For instance, camera assembly 114A may capture an image of cooktop surface 324 (e.g., from above along the vertical direction V). The captured image (or live image) may then be received at controller 510C and analyzed. Controller 510C may, via intelligent image analysis, recognize the locations of each heating element 326 present. Controller 510C may then define the cooking zones 340 (e.g., according to the locations of the heating elements 326). In some embodiments, dimensions of cooktop surface 324 are scaled such that the dimensions of the cooking zones 340 are defined by ratios or percentages of the width (e.g., along the lateral direction L) and depth (e.g., along the transverse direction T) of cooktop surface 324. For instance, a front left corner of cooktop surface 324 may define an origin (0,0). Thus, relative dimensions of the cooking zones may be defined along a coordinate system, as shown:

| | L | T | | |
|---|---|---|---|---|
| | coordinate | coordinate | L span | T span |
| Zone | [ratio] | [ratio] | [ratio] | [ratio] |
| Left Front (LF) | 0 | 0 | 0.32 | 0.50 |
| Left Rear (LR) | 0 | 0.50 | 0.32 | 0.50 |
| Right Front (RF) | 0.62 | 0 | 0.38 | 1.00 |
| Right Rear (RR) | 0.32 | 0.50 | 0.30 | 0.50 |

With reference to the right rear (RR) zone 340, the L coordinate refers to a starting point (along the lateral direction L) of RR zone 340 and the T coordinate refers to a starting point (along the transverse direction T) of RR zone 340. Thus, according to this example, RR zone 340 begins at a coordinate point of (0.32, 0.50). The L span refers to a length (along the lateral direction L) of RR zone 340 and the T span refers to a length (along the transverse direction T) of RR zone 340. Accordingly, controller 510C may establish a location of each cooking zone 340 according to a coordinate ratio of cooktop surface 324. Advantageously, cooking zones 340 may be confirmed regardless of a distance between camera assembly 114A and cooktop surface 324. It should be noted that the coordinate system described herein is presented by way of example only, and that additional or alternative defining characteristics of cooking zones 340 may be incorporated. Further, more or fewer zones 340 may be defined on cooktop surface 324 according to specific embodiments.

Referring now to FIG. 6, a method may be provided for use with system 100 (FIG. 1) in accordance with the present disclosure. In general, the various steps of the method as disclosed herein may, in exemplary embodiments, be performed by the controller 510C as part of an operation that the controller 510C is configured to initiate (e.g., a cookware identification operation). During such method, controller 510C may receive inputs and transmit outputs from various other components of the system 100. For example, controller 510C may send signals to and receive signals from cooking appliance 300, as well as other components within interactive assembly 110. In particular, the present disclosure is further directed to a method, as indicated by 500, for operating system 100.

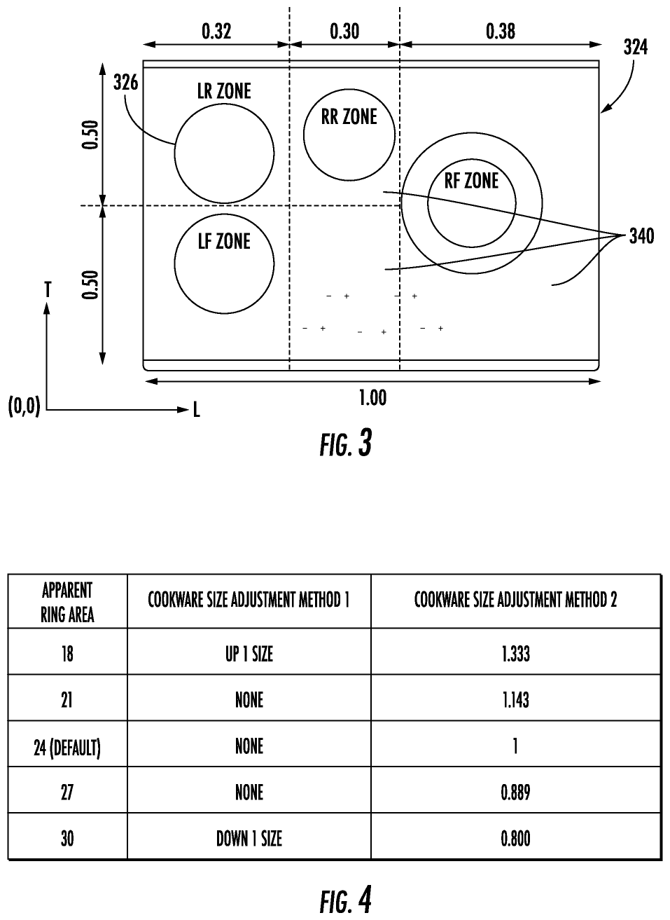

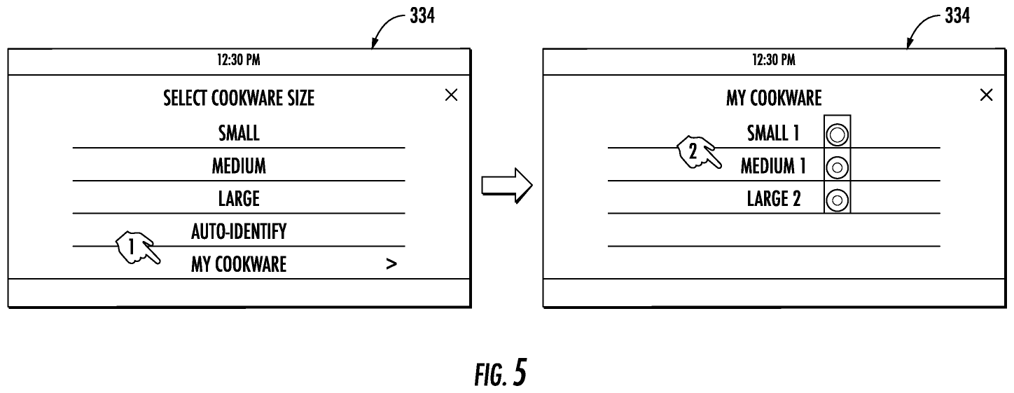

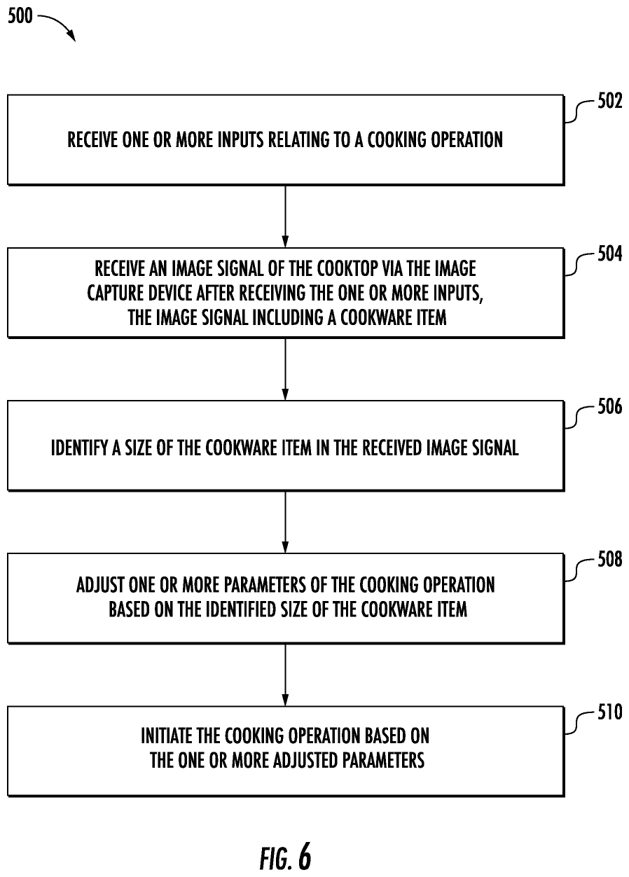

FIG. 6 depicts steps performed in a particular order for purpose of illustration and discussion. Those of ordinary skill in the art, using the disclosures provided herein, will understand that (except as otherwise indicated) the steps of the method disclosed herein can be modified, adapted, rearranged, omitted, or expanded in various ways without deviating from the scope of the present disclosure. Additionally or alternatively, method 500 will be described with occasional reference to FIGS. 4 and 5 as well.

At step 502, method 500 may include receiving one or more inputs relating to a cooking operation. In detail, the cooking appliance (e.g., cooking appliance 300) may recognize the initiation of a cooking operation according to one or more inputs provided by a user. The one or more inputs may include a set cooking temperature input, a food item input (e.g., eggs, meat, pancakes, vegetables, etc.), a recipe input (e.g., eggs over-easy, roasted mixed vegetables, etc.), a cooking method input (e.g., pan sear, slow boil, etc.), a selected heating zone (e.g., heating zone 340), a selected heating element (e.g., heating element 326), or the like.

The one or more inputs may be made directly through an onboard user interface (e.g., user interface panel 334), an interactive assembly (e.g., image monitor 112), a remote device (e.g., mobile device), or the like. For instance, the user may select, via the user interface, a specific heating element (e.g., among the plurality of heating elements on the cooktop surface). The user may then input a desired cooking temperature at which the selected heating element is to be driven. Accordingly, a default set of operational parameters (e.g., for the heating element, etc.) may be retrieved from an onboard memory, for example.

At step 504, method 500 may include receiving an image signal of the cooktop via an image capture device. In detail, the cooking appliance may include an image capture device (e.g., camera assembly 114A). The image capture device (or camera) may be directed toward the cooktop surface, as shown in FIG. 2. Thus, the camera may selectively obtain one or more images of cooktop surface. The obtained images may be image signals, for instance, live images transmitted directly to an image processor (e.g., within a controller). Additionally or alternatively, as explained above, the obtained images may be captured images. The captured images may be transmitted to the image processor for processing.

The image may be captured (or the image signal received) according to an input from the user. For instance, in response to receiving the one or more inputs relating to the cooking operation (e.g., such as the heating element selection), the method 500 may prompt the user to input information relating to a cookware item. The prompt may include a selection to activate the image capture device and retrieve the image signal of the cooktop. Additionally or alternatively, the cookware identification (e.g., size identification via the image capture device) may be performed automatically upon receiving an input to activate or enable a particular heating element. Accordingly, the image signal may include the cookware item therein. In additional or alternative embodiments, the prompt may request the user manually input cookware information, as will be described below.

Additionally or alternatively, the image capture device may focus on a particular zone (e.g., zone 340) of the cooktop. For instance, in receiving the one or more inputs relating to the cooking operation, the method 500 may determine which particular zone include the heating element to be used during the cooking operation. Accordingly, the image capture device may focus on the determined zone. Further, as will be described below, an analysis of the image or image signal may be limited to the determined zone. Accordingly, additional cookware items (or other various items) in inactive or non-selected zones may be ignored.

At step 506, method 500 may include identifying a size of the cookware item in the received image signal. For instance, one or more image analyses may be performed on the captured image(s). In detail, the received image signal may be evaluated or analyzed in order to find the cookware item provided on the cooktop. The image analysis may further confirm a location of the cookware item with respect to the selected heating element or cooking zone (e.g., as provided in step 502). Advantageously, misidentification of cookware items may be avoided by focusing the identification on the selected or active zone.

According to exemplary embodiments, this image analysis may use any suitable image processing technique, image recognition process, etc. As used herein, the terms “image analysis” and the like may be used generally to refer to any suitable method of observation, analysis, image decomposition, feature extraction, image classification, etc. of one or more images, videos, or other visual representations of an object. As explained in more detail below, this image analysis may include the implementation of image processing techniques, image recognition techniques, or any suitable combination thereof. In this regard, the image analysis may use any suitable image analysis software or algorithm to constantly or periodically monitor, for example, a cookware item positioned on the cooktop. It should be appreciated that this image analysis or processing may be performed locally (e.g., by the controller) or remotely (e.g., by offloading image data to a remote server or network).

Specifically, the analysis of the one or more images may include implementing an image processing algorithm. As used herein, the terms “image processing” and the like are generally intended to refer to any suitable methods or algorithms for analyzing images that do not rely on artificial intelligence or machine learning techniques (e.g., in contrast to the machine learning image recognition processes described below). For example, the image processing algorithm may rely on image differentiation, e.g., such as a pixel-by-pixel comparison of two sequential images. This comparison may help identify substantial differences between the sequentially obtained images, e.g., to identify movement, the presence of a particular object, the existence of a certain condition, etc. For example, one or more reference images may be obtained when a particular condition exists, and these references images may be stored for future comparison with images obtained during appliance operation. Similarities and/or differences between the reference image and the obtained image may be used to extract useful information for improving appliance performance.

According to exemplary embodiments, image processing may include blur detection algorithms that are generally intended to compute, measure, or otherwise determine the amount of blur in an image. For example, these blur detection algorithms may rely on focus measure operators, the Fast Fourier Transform along with examination of the frequency distributions, determining the variance of a Laplacian operator, or any other methods of blur detection known by those having ordinary skill in the art. In addition, or alternatively, the image processing algorithms may use other suitable techniques for recognizing or identifying items or objects, such as edge matching or detection, divide-and-conquer searching, greyscale matching, histograms of receptive field responses, or another suitable routine (e.g., executed at the controller based on one or more captured images from one or more cameras). Other image processing techniques are possible and within the scope of the present subject matter. The processing algorithm may further include measures for isolating or eliminating noise in the image comparison, e.g., due to image resolution, data transmission errors, inconsistent lighting, or other imaging errors. By eliminating such noise, the image processing algorithms may improve accurate object detection, avoid erroneous object detection, and isolate the important object, region, or pattern within an image.

In addition to the image processing techniques described above, the image analysis may include utilizing artificial intelligence (“AI”), such as a machine learning image recognition process, a neural network classification module, any other suitable artificial intelligence (AI) technique, and/or any other suitable image analysis techniques, examples of which will be described in more detail below. Moreover, each of the exemplary image analysis or evaluation processes described below may be used independently, collectively, or interchangeably to extract detailed information regarding the images being analyzed to facilitate performance of one or more methods described herein or to otherwise improve appliance operation. According to exemplary embodiments, any suitable number and combination of image processing, image recognition, or other image analysis techniques may be used to obtain an accurate analysis of the obtained images.

In this regard, the image recognition process may use any suitable artificial intelligence technique, for example, any suitable machine learning technique, or for example, any suitable deep learning technique. According to an exemplary embodiment, the image recognition process may include the implementation of a form of image recognition called region based convolutional neural network (“R-CNN”) image recognition. Generally speaking, R-CNN may include taking an input image and extracting region proposals that include a potential object or region of an image. In this regard, a “region proposal” may be one or more regions in an image that could belong to a particular object or may include adjacent regions that share common pixel characteristics. A convolutional neural network is then used to compute features from the region proposals and the extracted features will then be used to determine a classification for each particular region.

According to still other embodiments, an image segmentation process may be used along with the R-CNN image recognition. In general, image segmentation creates a pixel-based mask for each object in an image and provides a more detailed or granular understanding of the various objects within a given image. In this regard, instead of processing an entire image—i.e., a large collection of pixels, many of which might not contain useful information-image segmentation may involve dividing an image into segments (e.g., into groups of pixels containing similar attributes) that may be analyzed independently or in parallel to obtain a more detailed representation of the object or objects in an image. This may be referred to herein as “mask R-CNN” and the like, as opposed to a regular R-CNN architecture. For example, mask R-CNN may be based on fast R-CNN which is slightly different than R-CNN. For example, R-CNN first applies a convolutional neural network (“CNN”) and then allocates it to zone recommendations on the covn5 property map instead of the initially split into zone recommendations. In addition, according to exemplary embodiments, standard CNN may be used to obtain, identify, or detect any other qualitative or quantitative data related to one or more objects or regions within the one or more images. In addition, a K-means algorithm may be used.

According to still other embodiments, the image recognition process may use any other suitable neural network process while remaining within the scope of the present subject matter. For example, the step of analyzing the one or more images may include using a deep belief network (“DBN”) image recognition process. A DBN image recognition process may generally include stacking many individual unsupervised networks that use each network's hidden layer as the input for the next layer. According to still other embodiments, the step of analyzing one or more images may include the implementation of a deep neural network (“DNN”) image recognition process, which generally includes the use of a neural network (computing systems inspired by the biological neural networks) with multiple layers between input and output. Other suitable image recognition processes, neural network processes, artificial intelligence analysis techniques, and combinations of the above described or other known methods may be used while remaining within the scope of the present subject matter.

In addition, it should be appreciated that various transfer techniques may be used but use of such techniques is not required. If using transfer techniques learning, a neural network architecture may be pretrained such as VGG16/VGG19/ResNet50 with a public dataset then the last layer may be retrained with an appliance specific dataset. In addition, or alternatively, the image recognition process may include detection of certain conditions based on comparison of initial conditions, may rely on image subtraction techniques, image stacking techniques, image concatenation, etc. For example, the subtracted image may be used to train a neural network with multiple classes for future comparison and image classification.

It should be appreciated that the machine learning image recognition models may be actively trained by the appliance with new images, may be supplied with training data from the manufacturer or from another remote source, or may be trained in any other suitable manner. For example, according to exemplary embodiments, this image recognition process relies at least in part on a neural network trained with a plurality of images of the appliance in different configurations, experiencing different conditions, or being interacted with in different manners. This training data may be stored locally or remotely and may be communicated to a remote server for training other appliances and models. According to exemplary embodiments, it should be appreciated that the machine learning models may include supervised and/or unsupervised models and methods. In this regard, for example, supervised machine learning methods (e.g., such as targeted machine learning) may help identify problems, anomalies, or other occurrences which have been identified and trained into the model. By contrast, unsupervised machine learning methods may be used to detect clusters of potential failures, similarities among data, event patterns, abnormal concentrations of a phenomenon, etc.

It should be appreciated that image processing and machine learning image recognition processes may be used together to facilitate improved image analysis, object detection, or to extract other useful qualitative or quantitative data or information from the one or more images that may be used to improve the operation or performance of the appliance. Indeed, the methods described herein may use any or all of these techniques interchangeably to improve image analysis process and facilitate improved appliance performance and consumer satisfaction. The image processing algorithms and machine learning image recognition processes described herein are only exemplary and are not intended to limit the scope of the present subject matter in any manner.

Accordingly, in identifying the size of the cookware item in the image signal, the method 500 may determine the positioning of the cookware item within the selected cooking or heating zone. The image analysis may focus on the selected cooking zone to properly identify the cookware item and avoid erroneous detection and analysis of additional unused items that may be present on the cooktop. Additionally or alternatively, the image analysis may determine that no cookware item is present within the selected cooking zone. Accordingly, step 506 may include prompting the user to place the cookware item in the selected zone. Thereafter, step 504 may be repeated to obtain an additional image signal.

Upon confirming the presence of the cookware item in the selected zone, identifying the size of the cookware item may include determining a diameter of the cookware item. According to at least some embodiments, a single camera (e.g., camera assembly 114A) is used to capture or otherwise obtain the image signal. Thus, the image signal may be two-dimensional. The diameter of the cookware item may be determined according to the image analysis as described above.

In some instances, the distance between the camera and the cooktop may differ from a distance at which the machine learning image recognition and analysis process had been trained. For instance, the appliance (e.g., the cooktop, camera, controller, etc.) may be supplied with training data from the manufacturer before reaching an end user. The distance between the camera and the cooktop during the training may be different than the distance between the camera and the cooktop during use. Accordingly, a calibration may need to be performed to ensure accurate size identification.

A geometric feature extraction method may be performed (e.g., at any time during or prior to method 500). The geometric feature extraction may detect and recognize certain features on the cooktop, such as rings defining the heating element locations (e.g., as seen in FIG. 3). Upon extracting the features, the geometric feature extraction method may determine or calculate an area of the heating element (e.g., within the circle). The determined area may then be compared to known sizes (e.g., areas) of the heating elements (or heating areas) within the cooktop. For instance, the appliance may recognize the cooktop (e.g., by a model number) and thus retrieve the sizes (e.g., areas) of the heating elements according to the identified model of cooktop. For instance, the method may identify one heating element as a reference heating element and make comparisons accordingly.

Referring briefly to FIG. 4, the geometric feature extraction method may reference a table (e.g., a lookup table) according to the determined apparent size (e.g., the detected area) of the heating element (e.g., the reference heating element). The apparent ring area may be associated with one or more cookware size adjustment methods or factors. For example, in determining that the apparent ring area is 18 (e.g., square inches) and the reference heating element area is 24 (e.g., square inches), a first cookware size adjustment method implements and automatic correction to future determined cookware sizes by increasing the determined size by 1 size unit (e.g., from small to medium, medium to large, etc.). In another example, a second cookware size adjustment method determines a correction factor to be applied to future determined cookware sizes. As seen, again referring to the apparent ring area of 18 against the reference heating element area of 24, the correction factor may be 1.333. Thus, a determined diameter of a cookware item may be multiplied by 1.333 to obtain the true diameter. As shown, the correction factors in the second cookware size adjustment method may be stored in a table. Additionally or alternatively, the correction factors may be calculated according to the difference in the apparent ring area and the reference heating element area (e.g., according to one or more equations, interpolations, or extrapolations). It should be further noted that additional cookware size adjustment methods may be utilized or implemented, and the disclosure is not limited to the examples provided herein.

At step 508, method 500 may include adjusting one or more parameters of the cooking operation based on the identified size of the cookware item. In detail, the cooking operation may be a feedback controlled closed-loop cooking operation comprising a set of controller gains. In detail, the cooking operation may intelligently adjust one or more parameters (e.g., operational parameters) according to feedback with respect to the identified cookware item, a food being cooked, or the like. A temperature sensor (e.g., provided at or near the heating element) may continually send temperature signals to the controller which may then determine, for instance, an error value associated with the feedback controlled heating operation. The error value may be a difference between a temperature setpoint (e.g., the cooking temperature input) and an actual observed temperature (e.g., via the temperature sensor). The error value may be substituted into a feedback equation to determine an adjustment to be made to a control variable. For instance, the control variable may be a power level of the heating element (e.g., as controlled by the set of controller gains).

The closed-loop feedback control algorithm may be a proportional-integral-derivative (PID) algorithm or equation (e.g., equation or set of equations). In some embodiments, the algorithm may include a proportional algorithm, a proportional-integral algorithm, a proportional-derivative algorithm, or any suitable combination of terms. The PID controller may determine a proportional term (P), an integral term (I), and a derivative term (D). Each of the P, I, and D terms may include a gain value. Adjusting gain values of the P, I, and D terms may alter response parameters or behaviors (e.g., rise time of temperature, overshoot, settling time, steady state error, etc.) of the heating element, the cookware item, or the cooking operation as a whole. The parameters to be adjusted may include additional or alternative features from the controller gains. For instance, the adjustable parameters may include a total cook time, a power level of the heating element, or the like. Further, any suitable combination of parameters may be adjusted together, such as two or more of the gain values, a gain value and a cook time, etc.

Additionally or alternatively, the method 500 may include storing the identified size of the cookware item within a memory (e.g., of the controller). With brief reference to FIG. 5, an operational interface of the cooking appliance may include selectable features for cookware items. The selectable options may include cookware sizes such as small, medium, large, etc. The selectable options may additionally include an option to auto-identify the cookware item (e.g., as described above with reference to step 506). Moreover, the selectable options may include a plurality of stored cookware items (e.g., “My Cookware”). In identifying the cookware item size (e.g., step 506), the method 500 may present an option to store the cookware item for future reference. The stored cookware item may include each of the cookware size and the one or more adjusted operational parameters. Additionally or alternatively, the stored cookware item may include the captured image of the cookware item for reference. Further, the system (e.g., the controller) may assign default names or identifiers to the cookware items upon capturing the image of the cookware item. A user may then alter, adjust, or rename the cookware items (e.g., provided within the “My Cookware” selection). Thus, in identifying the size of the cookware item in future cooking operations, the user may select a previously used cookware item from the list of stored cookware items.

At step 510, method 500 may include initiating the cooking operation based on the one or more adjusted parameters. In detail, upon determining the appropriate size of the cookware item and implementing the adjusted parameters to the feedback controlled cooking operation, the cooking operation may be initiated. The selected heating element may be driven or directed according to the one or more adjusted parameters (and/or the initial input power levels, cooking method input, recipe input, etc.). In some embodiments, step 510 includes providing a prompt to the user to initiate the cooking operation (e.g., power the heating element). In additional or alternative embodiments, the cooking operation is automatically initiated upon receiving the inputs relating to the operation and inputs regarding the cookware size.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A cooking appliance defining a vertical direction, a lateral direction, and a transverse direction, the cooking appliance comprising:
a cooktop comprising a plurality of heating zones, each heating zone heated by at least one heating element;
an image capture device directed toward the cooktop; and
a controller operably connected to the image capture device and the at least one heating element, wherein the controller is configured to perform an operation, the operation comprising:
receiving one or more inputs relating to a cooking operation;
receiving an image signal of the cooktop via the image capture device after receiving the one or more inputs, the image signal comprising a cookware item;
identifying a size of the cookware item in the received image signal;
adjusting one or more parameters of the cooking operation based on the identified size of the cookware item; and
initiating the cooking operation based on the one or more adjusted parameters.

2. The cooking appliance of claim 1, wherein the image capture device is a camera positioned above the cooktop along the vertical direction.

3. The cooking appliance of claim 1, wherein receiving the one or more inputs relating to the cooking operation comprises:
receiving at least one of a set cooking temperature input, a food item input, a recipe input, a cooking method input, or a selected heating zone input.

4. The cooking appliance of claim 1, wherein identifying the size of the cookware item comprises:
analyzing, via one or more machine learning algorithms, the received image signal comprising the cookware item; and
determining a diameter of the cookware item via the received image signal analysis.

5. The cooking appliance of claim 4, wherein identifying the size of the cookware item further comprises:
determining a heating zone of the plurality of heating zones in which the cookware item is located.

6. The cooking appliance of claim 1, wherein initiating the cooking operation comprises:
directing the at least one heating element of a selected heating zone according to the one or more adjusted parameters.

7. The cooking appliance of claim 1, wherein the cooking operation is a feedback controlled closed-loop cooking operation comprising a set of controller gains, the set of controller gains comprising a proportional gain value, an integral gain value, and a derivative gain value.

8. The cooking appliance of claim 7, wherein adjusting the one or more parameters comprises:
adjusting at least one of the proportional gain value, the integral gain value, or the derivative gain value.

9. The cooking appliance of claim 1, wherein the operation further comprises:
determining a distance between the image capture device and the cooktop after receiving the one or more inputs relating to the cooking operation; and
incorporating a size adjustment to the identified size of the cookware item in response to determining the distance between the image capture device and the cooktop.

10. The cooking appliance of claim 1, wherein the operation further comprises:
storing the identified size of the cookware item within a memory of the controller.

11. A method of operating a cooking appliance, the cooking appliance comprising a plurality of heating zones, each heating zone selectively heated by at least one heating element, and an image capture device directed toward the plurality of heating zones, the method comprising:
receiving one or more inputs relating to a cooking operation;
receiving an image signal of the plurality of heating zones via the image capture device after receiving the one or more inputs, the image signal comprising a cookware item;
identifying a size of the cookware item in the received image signal;
adjusting one or more parameters of the cooking operation based on the identified size of the cookware item; and
initiating the cooking operation based on the one or more adjusted parameters.

12. The method of claim 11, wherein the image capture device is a camera positioned above the plurality of heating zones along a vertical direction.

13. The method of claim 11, wherein receiving the one or more inputs relating to the cooking operation comprises:
receiving at least one of a set cooking temperature input, a food item input, a recipe input, a cooking method input, or a selected heating zone input.

14. The method of claim 11, wherein identifying the size of the cookware item comprises:
analyzing, via one or more machine learning algorithms, the received image signal comprising the cookware item; and
determining a diameter of the cookware item via the received image signal analysis.

15. The method of claim 14, wherein identifying the size of the cookware item further comprises:
determining a heating zone of the plurality of heating zones in which the cookware item is located.

16. The method of claim 11, wherein initiating the cooking operation comprises:
directing the at least one heating element of a selected heating zone according to the one or more adjusted parameters.

17. The method of claim 11, wherein the cooking operation is a feedback controlled closed-loop cooking operation comprising a set of controller gains, the set of controller gains comprising a proportional gain value, an integral gain value, and a derivative gain value.

18. The method of claim 17, wherein adjusting the one or more parameters comprises:
adjusting at least one of the proportional gain value, the integral gain value, or the derivative gain value.

19. The method of claim 11, further comprising:
determining a distance between the image capture device and the plurality of heating zones after receiving the one or more inputs relating to the cooking operation; and
incorporating a size adjustment to the identified size of the cookware item in response to determining the distance between the image capture device and the plurality of heating zones.

20. The method of claim 11, further comprising:
storing the identified size of the cookware item within a memory of cooking appliance.
